(19) United States
(12) Patent Application Publication
(10) Pub. No.: US 2015/0127505 A1
(43) Pub. Date: May 7, 2015

(54) SYSTEM AND METHOD FOR GENERATING AND TRANSFORMING DATA PRESENTATION

(71) Applicant: Capital One Financial Corporation, McLean, VA (US)

(72) Inventor: Vishal PARIKH, Richmond, VA (US)

(21) Appl. No.: 14/513,750

(22) Filed: Oct. 14, 2014

Related U.S. Application Data
(60) Provisional application No. 61/889,796, filed on Oct. 11, 2013.

(51) Int. Cl. G06Q 40/02; G09G 5/38; G06T 3/60

(52) U.S. Cl. CPC G06Q 40/02; G09G 5/38; G06T 3/60; G06T 2200/24; G06T 2210/32; G09G 2354/00; G09G 2340/0492; G09G 2358/00
USPC 705/35; 345/619; 345/659

(57) ABSTRACT

A system and method in accordance with example embodiments may include systems and methods for generating and transforming data presentation. The method may include receiving, using a processor, a request for a web page, and submitting, by the processor, the request to a computer server system. The request can include a user identification and a user password. The method may further include receiving, from the computer server system, data corresponding to the requested web page. Further, the method includes storing, in a memory, the received data, and causing the received data to be shown on a display associated with the user device.

### CROSS-REFERENCE TO RELATED APPLICATIONS

The present application contains subject matter related to and claims the benefit of U.S. Provisional Patent Application No. 61/889,796, filed on Oct. 11, 2013, the entire contents of which is incorporated herein by reference.

### TECHNICAL FIELD

The present disclosure relates to systems and methods for generating and transforming data presentation and, more particularly, to systems and methods for generating and transforming data displayed on user devices.

### BACKGROUND

Financial institutions provide account holders or potential account holders with balance information using a traditional balance statement that typically is either mailed to the account holders or made available to account holders via an online device. These traditional balance statements do not include the ability to change the format of data representation automatically from a line item representation to bar graphs, pie charts, or the like based on an account holder's preferences. Thus, an account holder may not be able to view data in a manner preferred by that account holder or in a format designed to convey complex information easily. In addition, an account holder may not be able to change the manner of representation quickly.

These and other drawbacks exist.

### SUMMARY OF THE DISCLOSURE

In one example embodiment, the present disclosure is directed to a method for generating and transforming data presentation on a user device. The method includes receiving, receiving, using a processor, a request for a set of data; submitting, by the processor, the request for the set of a data to a computer server system, wherein the request includes a user identification and a user password; receiving, from the computer server system, the requested set of data; storing, in a memory, the received set of data; retrieving, from the memory, a subset of the received set of data; and causing the subset of the received set of data to be shown on a display associated with the user device based on a detected orientation of the user device, display preferences, and user input.

In various aspects, the method includes wherein the receiving the request for the set of data includes receiving, via a user interface of the user device, the request for the set of data.

In various aspects, the method includes wherein the submitting the request to the computer server system includes receiving, via the user device, the user identification and the user password; authenticating the user identification and the user password; and submitting, to the computer server system, the request and the authenticated user identification and user password.

In various aspects, the method includes wherein the submitting the request to the computer server system includes transmitting, via a network, the request to the computer server system.

In various aspects, the method includes wherein the causing the subset of the received set of data to be displayed on the display includes accessing, in the memory, the stored data; and extracting the subset of the data to be shown on the display.

In various aspects, the method includes wherein the receiving the requested set of data includes receiving the set of data in a standardized format.

In various aspects, the method includes wherein the requested set of data is associated with a financial account.

In various aspects, the method includes wherein the computer server system is associated with a financial services institution.

In various aspects, the method includes wherein the requested set of data is associated with a financial account.

The present disclosure is also directed to a method for generating and transforming data presentation. The method includes receiving, via a user interface of a user device, a request for data; determining an orientation of a display associated with the user device; determining user preferences corresponding to a user preferred display format; retrieving, from a memory associated with the user device, stored data; and displaying, on a display associated with the user device, the retrieved data in a display format based on the detected orientation and the user preferred display format.

In various aspects, the method includes receiving, via the user interface of the user device, a user identification and a user password; and authenticating, by the user device, the user identification and the user password.

In various aspects, the method includes wherein the user identification and the user password are associated with a financial account.

In various aspects, the method includes wherein displaying the retrieved data in the display format includes when the user identification and the user password are authenticated, displaying the retrieved data in the display format based on the detected orientation and the user preferred display format.

In various aspects, the method includes wherein the retrieving the stored data includes accessing, in the memory, the stored data; and extracting display data to be shown on the display.

In various aspects, the method includes wherein the determining the orientation of the display includes receiving, from an orientation unit of the user device, an orientation indication of one of a portrait orientation and a landscape orientation.

In various aspects, the method includes wherein the receiving the orientation indication includes receiving, from then orientation unit of the user device, an indication of an angle of the user device.

In various aspects, the method includes wherein the determining the orientation of the display includes receiving, via the user interface of the user device, a user display orientation input.

In various aspects, the method includes wherein the data is associated with a financial account.

### BRIEF DESCRIPTION OF THE DRAWINGS

Various embodiments of the present disclosure, together with further objects and advantages, may best be understood by reference to the following description taken in conjunction with the accompanying drawings, in the several figures of which like reference numerals identify like elements, and in which:

FIG. 1 is a diagram illustrating an example system for generating and transforming data presentation, consistent with various embodiments;

FIG. 2 is a diagram illustrating an example user device for generating and transforming data presentation, consistent with various embodiments;

FIG. 3 is a flowchart illustrating an example method of generating and transforming data presentation, consistent with various embodiments;

FIG. 4 is a flowchart illustrating an example method of generating and transforming data presentation, consistent with various embodiments;

FIG. 5 is a flowchart illustrating an example method of generating and transforming data presentation, consistent with various embodiments;

FIG. 6a is an example screenshot of generating and transforming data presentation, consistent with various embodiments;

FIG. 6b is an example screenshot of generating and transforming data presentation, consistent with various embodiments;

FIG. 7a is an example screenshot of generating and transforming data presentation, consistent with various embodiments;

FIG. 7b is an example screenshot of generating and transforming data presentation, consistent with various embodiments;

FIG. 8a is an example screenshot of generating and transforming data presentation, consistent with various embodiments;

FIG. 8b is an example screenshot of generating and transforming data presentation, consistent with various embodiments;

FIG. 8c is an example screenshot of generating and transforming data presentation, consistent with various embodiments; and

FIG. 9 is a diagram illustrating an example system for generating and transforming data presentation, consistent with various embodiments.

### DETAILED DESCRIPTION OF THE DISCLOSURE

The following description is intended to convey a thorough understanding of the embodiments described by providing a number of specific example embodiments and details involving systems and methods for generating and transforming data presentation. That is, the example embodiments involve systems and methods for receiving data, determining an orientation of a display, and displaying the data based on user preferences and the determined orientation. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial services institution, such as, for example, a depository institution, is used in the examples of the disclosure. However, the disclosure is not intended to be limited to financial services institutions only. Instead, the disclosed system and method can be extended to any entity that seeks to generate, display, and transform data without departing from the spirit and scope of the disclosure.

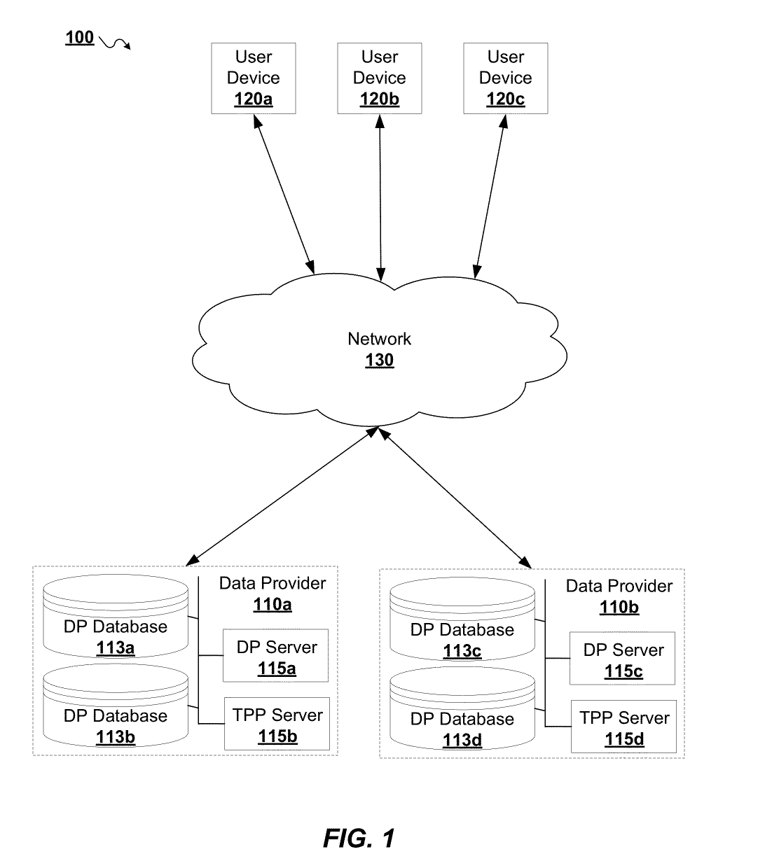

According to the various embodiments of the present disclosure, systems and methods are disclosed to generate and transform data presentation using data stored in a memory associated with a user device. The systems and methods depicted in FIGS. 1 through 5, for example, allow users to manage the display of data on the user's device such that complex data can be shown in a format that is most visually accessible, intuitive, preferred and/or understandable by the user. In one example embodiment, the systems and methods of the disclosure are configured to operate in connection with a user device (e.g., a smartphone, an electronic reader, tablet, wearable device, a laptop computer, etc. a set top box, a cable card, etc.) that allows a user to access content. In such an embodiment, the system may include one or more software applications stored in memory associated with the user device, and the memory may be accessed by one or more computer processors associated with the user device and the stored software applications executed by the one or more computer processors. The systems and methods may further include one or more corresponding server applications and one or more cloud-based analytics and reporting services, which may be operated by data service providers, for example. The data service providers may provide raw data that is transmitted to and subsequently stored in the memory of the user device, and the software applications executing on the user device (e.g., a mobile banking application, mobile optimized website and/or the like) may dynamically access the memory, retrieve the stored data, and display the data in a format that is most visually accessible, intuitive, preferred and/or understandable by the user. In the disclosed embodiments, the illustrative data provider may be a financial services institution, but the data provider also may be any type of entity that provides data to a user via a user device.

FIG. 1 is a diagram illustrating an example system for generating and transforming data for presentation on a user device, according to the various embodiments. As shown in FIG. 1, an example system 100 may include one or more data providers 110 (e.g., data provider 110a and data provider 110b), one or more user devices 120 (e.g., user device 120a, user device 120b, and user device 120c), and network 130. As shown in FIG. 1, one or more data providers 110 may be connected to and/or communicatively coupled with one or more user devices 120 via network 130.

Data providers 110 may be any type of entity that provides any type of data to end users via user devices. In the examples provided herein, data providers 110 may include financial institutions including, by way of example and not limitation, depository institutions (e.g., banks, credit unions, building societies, trust companies, mortgage loan companies, pre-paid gift cards or credit cards, etc.), contractual institutions (e.g., insurance companies, pension funds, mutual funds, etc.), investment institutions (e.g., investment banks, underwriters, brokerage funds, etc.), and other non-bank financial institutions (e.g., pawn shops or brokers, cashier's check issuers, insurance firms, check-cashing locations, payday lending, currency exchanges, microloan organizations, crowd-funding or crowd-sourcing entities, third-party payment processors, etc.). In an example embodiment, data providers 110 may perform financial transactions (e.g., process transactions by a third-party payment processor, etc.) and/or enable the performance of financial transactions (e.g., issue cards for other financial accounts, authorize financial transactions, etc.) on behalf of one or more end users.

Data providers 110 may include one or more data provider (DP) databases 113 (e.g., DP database 113a, DP database 113b, DP database 113c, and DP database 113d) and one or more DP servers 115 (e.g., DP server 115a, DP server 115b, DP server 115c, and DP server 115d). As shown in FIG. 1, DP databases 113 and DP servers 115 are disclosed as included within data providers 110; however, it is anticipated that DP databases 113 and DP servers 115 may be disposed apart from data providers 110, logically and/or physically. Moreover, one or more of DP databases 113 and/or DP servers 115 may be owned by one or more third parties (not shown), and the third parties may provide and/or enable the functionality and services of DP databases 113 and/or DP servers 115 for use and utilization by data providers 110.

DP databases 113 may be one or more computing devices configured to maintain databases, e.g., organized collections of data and their data structures, and/or execute database management systems, e.g., computer programs configured to control the creation, maintenance, and use of the database. Collectively, databases and their database management systems may be referred to as database systems. As used herein, DP databases 113 may refer to databases, database management systems, and/or like database systems. In some aspects, DP databases 113 may be configured to maintain databases, while database management systems may be stored and executed on one or more remote computing devices, such as user devices 120, and/or one or more remote servers, such as DP servers 115. DP databases 113 may include software database programs configured to store data associated with DP servers 115 and their associated applications or processes, such as, for example, standard databases or relational databases. DP databases 113 also may include relationship database management systems (RDBMS) that may be configured to run as a server on DP servers 115. DP databases 113 may be configured to transmit and/or receive information to and/or from user devices 120, DP servers 113, and/or other DP databases 113 directly and/or indirectly via any combination of wired and/or wireless communication systems, method, and/or devices, including, for example, network 130. In various embodiments, DP databases 113 may include the system of record for a financial institution.

DP servers 115 may be physical computers, or computer systems, configured to run one or more services to support users of other computers on one or more networks and/or computer programs executing on physical computers, or computer systems, and configured to serve the requests of other programs that may be operating on one or more servers (not shown) or on other computing devices, such as user devices 120. DP servers 115 may include, by way of example and without limitation, communication servers, database servers, fax servers, file servers, mail servers, print servers, name servers, web servers, proxy servers, gaming servers, etc. DP servers 115 may be configured to transmit and/or receive information to and/or from user devices 120, other servers (e.g., DP servers 115, Internet Service Provider (ISP) servers (not shown), etc.), and/or databases 113, directly and/or indirectly via any combination of wired and/or wireless communication systems, method, and/or devices, including, for example, network 130. DP servers 115 may include one or more physical servers, or server systems, and/or one or more proxy servers, each configured to run one or more services to support other computers or computer systems, such as, for example, client computer systems (not shown). The same server devices may perform the roles of physical DP servers 115 and/or proxy DP servers 115.

User devices 120 may be any type of electronic device and/or component configured to execute one or more processes. In the example embodiments disclosed herein, user devices 120 may include, for example, one or more mobile devices, such as, for example, personal digital assistants (PDA), tablet computers and/or electronic readers (e.g., iPad, Kindle Fire, Playbook, Touchpad, etc.), telephony devices, smartphones, cameras, music playing devices (e.g., iPod, etc.), wearable devices (e.g., Google Glass and smart watches), etc. It is anticipated, however, that the disclosed systems and methods may be used, for example, in connection with other types of user devices 120, such as, for example, server computers, clients computers, desktop computers, laptop computers, network computers, workstations, personal digital assistants (PDA), tablet PCs, printers, copiers, scanners, projectors, home entertainment systems, audio/visual systems, home security devices, intercoms, appliances, etc., or any component or sub-component of another user device 120 or assemblage, such as, for example, a car, a train, a plane, a boat, etc. Although not illustrated, user devices 120 also may include servers and/or databases. User devices 120 may be configured to transmit and/or receive information to and/or from other user devices 120, data providers 110, DP databases 113, and/or DP servers 115 directly and/or indirectly via any combination of wired and/or wireless communication systems, method, and devices, including, for example, network 130.

Network 130 may enable communication between and among one or more data providers 110 and one or more user devices 120. For example, network 130 may be one or more of a wireless network, a wired network or any combination of wireless network and wired network. For example, network 130 may include, without limitation, one or more of telephone broadband and/or copper lines networks, cellular networks, fiber optic networks, passive optical networks, cable networks, satellite networks, wide area networks (WANs), local area networks (LANs), personal area networks (PANs), or a global network such as the Internet.

Network 130 may further include, for example and without limitation, networks operating according to the Global System for Mobile Communication (GSM), Personal Communication Service (PCS), Wireless Application Protocol (WAP), Multimedia Messaging Service (MMS), Enhanced Messaging Service (EMS), Short Message Service (SMS), Time Division Multiplexing (TDM), Code Division Multiple Access (CDMA), D-AMPS, Wi-Fi, Fixed Wireless Data, IEEE Ethernet standard 802.3, IEEE Wireless standards 802.11 and 802.15 or any other wired or wireless network for transmitting and receiving data. Network 130 also may utilize one or more protocols of one or more network elements to which they are communicatively coupled. Network 130 may translate to or from other protocols to one or more protocols of network devices. Although network 130 is depicted as a single network, it should be appreciated that according to one or more embodiments, network 130 may comprise a plurality of interconnected networks, such as, for example, the Internet, a service provider's network, a cable television network, corporate networks, and home networks.

Although FIG. 1 depicts data providers 110 and user devices 120 communicating with one another using an indirect network connection, such as a connection through network 130, those skilled in the art may appreciate that data providers 110 and user devices 120 may communicate with one another using a direct communications link or a communications link separate from network 130. For example, data providers 110 and user devices 120 may communicate with one another via point-to-point connections (e.g., Bluetooth connections, etc.), peer-to-peer connections, etc. By way of example, data providers 110 and user devices 120 may communicate with one another via mobile contactless communication and/data transfers, remote electronic communication and/data transfers, magnetic stripe communication and/data transfers, secure chip technology communication and/data transfers, person-to-person communication and/data transfers, and the like. Additionally, data providers 110 and user devices 120 may communicate with one another utilizing standardized transmission protocols, for example and not by way of limitation, ISO/IEC 14443 A/B, ISO/IEC 18092, MiFare, FeliCa, tag/smartcard emulation, and the like. Also data providers 110 and user devices 120 may communicate with one another utilizing transmission protocols and methods that are developed in the future using other frequencies or modes of transmission. Data providers 110 and user devices 120 may communicate with one another via existing communication and/data transfer techniques, such as, for example RFID. Also, data providers 110 and user devices 120 may communicate with one another via new and evolving communication and/data transfer standards including internet-based transmission triggered by near-field communications (NFC).

In the embodiment of FIG. 1, user devices 120 may communicate directly with data providers 110 via network 130 using standard Internet Protocols, such as HTTP, transmission control protocol (TCP), internet protocol (IP), etc. For example, HTTP requests from user devices 120 may be encapsulated in TCP segments, IP datagrams, and Ethernet frames and transmitted to data providers 110. Third parties, for example, may participate as intermediaries in the communication, such as, for example, Internet Service Providers (ISPs) or other entities that provide routers and link layer switches. Such third parties may not, however, analyze or review the contents of the Ethernet frames beyond the link layer and the network layer, but instead analyze only those parts of the packet necessary to route communications among and between from user devices 120 and data providers 110.

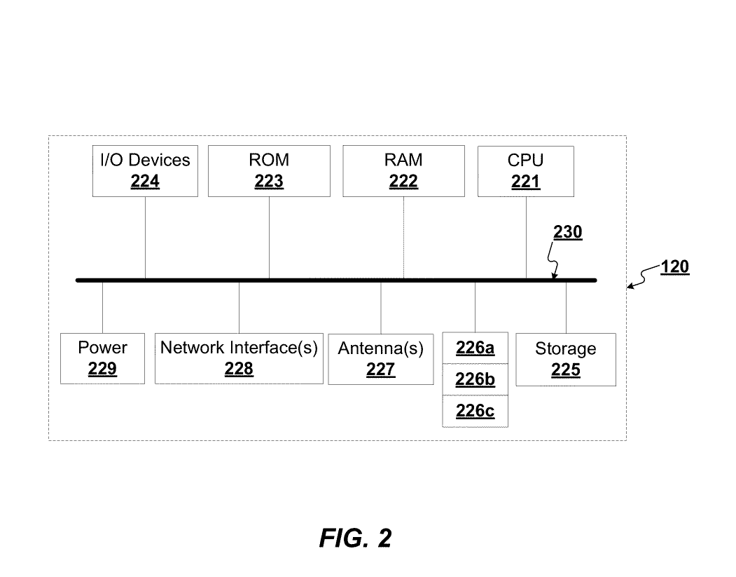

FIG. 2 is a block diagram of an example user device 120, according to various embodiments. It should be readily apparent that the example user device 120 depicted in FIG. 2 represents a generalized schematic illustration and that other components/devices may be added, removed, or modified. In embodiments, user device 120 may be configured to include address translation and full virtual-memory services.

As shown in FIG. 2, each user device 120 may include one or more of the following components: at least one central processing unit (CPU) 221, which may be configured to execute computer program instructions to perform various processes and methods, random access memory (RAM) 222 and read only memory (ROM) 223, which may be configured to access and store data and information and computer program instructions, I/O devices 224, which may be configured to provide input and/or output to user device 120 (e.g., keyboard, mouse, display, speakers, printers, modems, network cards, etc.), and storage media 225 or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system 226a, application programs 226b including, for example, web browser application, email application and/or other applications, and data files 226c may be stored.

Each user device 120 may include antennas 227, network interfaces 228 that may provide or enable wireless and/or wire line digital and/or analog interface to one or more networks, such as network 130, over one or more network connections (not shown), a power source 229 that provides an appropriate alternating current (AC) or direct current (DC) to power one or more components of user device 120, and a bus 230 that allows communication among the various disclosed components of user device 120 of FIG. 2.

Although not shown, each user device 120 may include one or more mechanisms and/or devices by which user device 120 may perform the methods as described herein. For example, user device 120 may include one or more encoders and/or decoders, one or more interleavers, one or more circular buffers, one or more multiplexers and/or de-multiplexers, one or more permuters and/or depermuters, one or more encryption and/or decryption units, one or more modulation and/or demodulation units, one or more arithmetic logic units and/or their constituent parts, etc. These mechanisms and/or devices may include any combination of hardware and/or software components and may be included, in whole or in part, in any of the components shown in FIG. 2.

In one or more exemplary designs of user device 120 of FIG. 2, the functions described may be implemented in hardware, software, firmware, or any combination thereof. For example, user device 120 may include an accelerometer or other similar device to measure proper acceleration for user interface control. User device 120 also may include a tilt sensor or similar device for user interface control. Where, for example, the user device 120 is an Apple device, the UIAccelerometer class associated with the iOS software may enable the user device software (e.g., a mobile banking application) to receive acceleration related data and determine user device orientation. Where, for example, the user device 120 is an Android-based device, the SensorManager API associated with the Android operating system may enable the user device software (e.g., a mobile banking application) to receive acceleration related data and determine user device orientation. If implemented in software, the functions may be stored as one or more instructions or code on computer-readable medium, including the computer-readable medium described above (e.g., RAM 222, ROM 223, storage media 225, etc.).

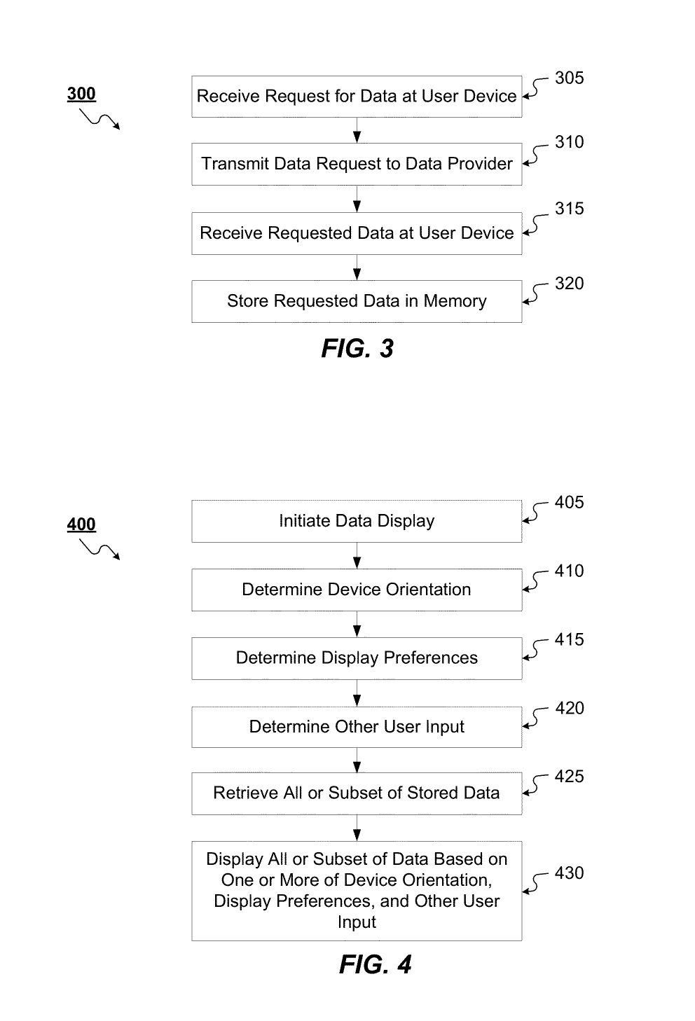

FIG. 3 is an example flowchart 300 illustrating generation and transformation of data for display to a user, according to various embodiments. Specifically, FIG. 3 illustrates an embodiment in which a user submits a request for data associated with a data provider, such as data provider 110, and the data is returned to a user device, such as user device 120, associated with the user.

As shown in FIG. 3, a user device, such as user device 120, may receive a request for data (305). User device 120 may receive the request for data via a user interface that is operating on, or in conjunction with, user device 120. The user interface may be associated with an application executing on user device 120. The application also may be a dedicated application, e.g., an application whose primary purpose is to interact with one or more data providers 110. The user interface may be a multi-purpose application, such as an internet browser application, and the user may request data by directing the browser to a web page, such as, for example, a web page associated with one or more data providers 110. User device 120 may receive a user identification and/or user password via the user interface operating on, or in conjunction with, user device 120. The user identification and/or user password may be stored on the user device 120, and the user may not enter the user identification and/or user password via the user interface upon every data request.

In block 310, user device 120 may transmit the data request to one or more data providers, such as, for example, one or more data providers 110. User device 120 may transmit the data request via, for example, network 130. The data request may be, for example, a request for data associated with a financial account. The requested data may be, for example, data associated with a financial transaction history. The data request also may include the user identification and/or user password. Additionally and/or alternatively, the request may include other information, such as a verification code, location information (e.g., zip code corresponding to the user's location, etc.), etc.

In block 315, user device 120 may receive the requested data. The user device 120 may receive the requested data from one or more data providers 110. The received data may be received using any language or format that allows for transmission of data over a network connection, such as network 130. For example, JavaScript Object Notation (JSON) may be used to exchange data in the systems and methods disclosed herein. A JSON schema may be used to specify a JSON-based format that defines the structure of JSON data for validation, documentation, and interaction control. In other words, a JSON schema may be used to provide a predefined agreement for the JSON data required by a given application, and how that data may be modified. As another example, extensible markup language (XML) also may be used to transmit data between a server and web application according to the disclosed embodiments. In some embodiments,

In block 320, user device 120 may store the requested data in memory. The memory may be associated with, or accessible by, user device 120. Memory may include for example, one or more of RAM 222, ROM 223, and/or storage 225, as illustrated in FIG. 2. Memory also may include storage that is not part of user device 120, but instead is accessible by user device 120, such as, for example, cloud storage.

FIG. 4 is an example flowchart 400 illustrating generation and transformation of data for display to a user, according to various embodiments. Specifically, FIG. 4 illustrates an example embodiment in which a user initiates display of data on a user device, such as user device 120, and the data is displayed according to a determined user device orientation, stored user preferences, and/or a current display format.

As shown in FIG. 4, in block 405, a user may initiate display of data on user device 120. As discussed above in connection with a user request for data (e.g., as in, for example, block 305 of FIG. 3), a user may initiate a data display via a user interface that is operating on, or in conjunction with, user device 120. The user interface may be associated with an application executing on user device 120. Additionally, the application may be a dedicated and/or native applications, e.g., applications whose primary purpose is to interact with one or more data providers 110. The user interface may be a multi-purpose application, such as an internet browser application, and the user may request data by directing the browser operating on user device 120 to a web page, such as, for example, a web page associated with one or more data providers 110. In addition, a user may enter a user identification and/or user password via the user interface operating on, or in conjunction with, user device 120. The user identification and password, once verified and/or authenticated, may cause the method disclosed herein to begin executing. The user identification and/or user password may be stored on the user device 120 and, in some embodiments, the user may not enter the user identification and/or user password via the user interface upon every data display initiation. In various embodiments, the data may already be displayed on user device 120 and, when a user initiates a display of data, the user may be initiating display of new data that is requested and downloaded, as discussed in connection with FIG. 3, and/or the user may be initiating display of previously displayed data in a new format. In addition, the systems and methods disclosed herein may not be performed unless and/or until the user identification and/or user password have been verified or authenticated. That is, before performing display of data, in accordance with various embodiments, the user identification and/or user identification may be authenticated and/or verified using, for example, an application executing on user device 120 and/or an application executing in connection with data provider 110.

In block 410, a current orientation of user device 120 may be determined. Determining an orientation of user device 120 may be triggered by a first request to display data (e.g., as in, for example, block 405 of FIG. 4). Determining device orientation also may be triggered by a change in orientation of user device 120 (e.g., a change from portrait orientation to a landscape orientation or vice versa). Device orientation may be determined using an orientation application programming interface (API) executing on user device 120 in conjunction with an accelerometer as explained above. For example, user device 120 may include an accelerometer or other similar device to measure proper acceleration for user interface control. User device 120 also may include a tilt sensor or similar device for user interface control. Where, for example, the user device 120 is an Apple device, the UIAccelerometer class associated with the iOS software may enable the user device software (e.g., a mobile banking application) to receive acceleration related data and determine user device orientation. Where, for example, the user device 120 is an Android-based device, the SensorManager API associated with the Android operating system may enable the user device software (e.g., a mobile banking application) to receive acceleration related data and determine user device orientation. An accelerometer may be, for example, a physical device within user device 120 (not shown) that measure proper acceleration or the acceleration relative to a free-fall, or inertial, observer who is momentarily at rest relative to the object being measured, i.e., user device 120. Device orientation may be determined using two-axis coordinates, three-axis coordinates, etc. When device orientation is determined using two-axis coordinates, it may be understood that user device 120 is detecting, for example, the orientation of display (e.g., portrait or landscape). When device orientation is determined using three-axis coordinates, it may be understood that user device 120 is detecting, for example, the orientation of display of the user device 120 (e.g., portrait or landscape) or x-axis and y-axis orientation and horizontal angle of the display or z-axis orientation. In embodiments, device orientation may be input by a user, for example, via a user interface operating on user device 120.

In block 415, display preferences may be determined. The display preferences may be associated with one or more of a user, user account, user identification, user device 120, etc. The display preferences may have been previously stored in connection with one or more of a user, user account, user identification, user device 120, etc. The display preferences may be stored in a memory associated with user device 120, such as, for example, one or more of RAM 222, ROM 223, and/or storage 225, as illustrated in FIG. 2. Additionally and/or alternatively, display preferences may be stored in a memory associated with one or more data providers 110, such as, for example, DP databases 113.

In block 420, other user input may be determined. User device 120 may determine if the user has input other data or commands via, for example, a user interface associated with user device 120. The user data or commands may include one or more of, alone and/or in combination, keyboard tap(s), screen tap(s), gesture(s), eye movement(s), voice command(s), etc. that are detected by user device 120. The user data or commands may include, for example, instructions to navigate to different web or internet pages, navigate or change to different application pages or views, or show different data.

As shown in FIG. 4, in block 425, all or a subset of the stored data may be retrieved. Stored data may be retrieved from a memory of user device 120, such as, for example, one or more of RAM 222, ROM 223, and/or storage 225, as illustrated in FIG. 2. Additionally and/or alternatively, data may be retrieved from a memory associated with one or more data providers 110, such as, for example, DP databases 113, or from one or more cloud storage memories. The retrieved all or subset of data may be the same all or subset of data as is currently displayed on user device 120 and/or it may be different data than that displayed on a display of user device 120.

In block 430, all or a subset of the stored data may be displayed based on one or more of the determined user device orientation, user display preferences, and current display data. The display of data may be changed visually such that, for example, data that is currently displayed in a tabular format is displayed in one or more of a pie chart, bar chart, or other graphical representation. Similarly, data that is currently displayed in a graphical representation (e.g., pie chart, bar chart, etc.) is displayed in a tabular format. The change in data display may be based, in part, on a detected orientation of the user device 120. For example, data represented in a tabular format when user device 120 is in a portrait orientation may be represented in a graphical representation (e.g., pie chart, bar chart, etc.) when the display device is detected to be in a landscape orientation. Stored user preferences may provide, for example, rules and/or constraints for display of data on user device 120.

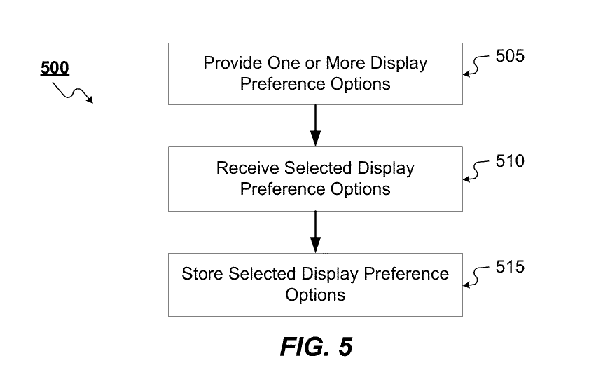

FIG. 5 is an example flowchart 500 illustrating generation and transformation of data for display to a user, consistent with various embodiments. Specifically, FIG. 5 illustrates an embodiment in which a user may set preferences for the display of data on a user device based on a device orientation.

As shown in FIG. 5, in block 505, a user may be provided with one or more display preference options. The one or more display preference options may be provided to a user via, for example, user device 120 or any computing device that allows a user to access and change the user's preferences. For example, the one or more preference options may be provided via an dedicated application operating on user device 120, a browser operating on user device 120 or any other computing device, etc. The one or more preference options may include, for example, the option to display data in a given format based on a data type and/or an orientation of the user device 120. The one or more preference options may include the option of maintaining a display format regardless of an orientation of the user device 120.

In block 510, user device 120 may receive selected display preference options from a user. User device 120 may receive the selected display preference options by an input provided via a user interface that is operating on, or in conjunction with, user device 120. The user interface may be associated with an application executing on user device 120. Additionally, the application may be dedicated or native applications, e.g., applications whose primary purpose is to interact with one or more data providers 110. The user interface also may be a multi-purpose application, such as an internet browser application, and the user may request data by directing the browser to a web page, such as, for example, a web page associated with one or more data providers 110. In addition, user device 120 may receive a user identification and/or user password via the user interface operating on, or in conjunction with, user device 120 prior to, or in connection with, receipt of the selected preference options. The user identification and/or user password may be stored on the user device 120, and the user may not enter the user identification and/or user password via the user interface of user device 120 upon every data request.

In block 515, the selected display preference options may be stored. The selected display preference options may be stored in a memory of user device 120, such as, for example, one or more of RAM 222, ROM 223, and/or storage 225, as illustrated in FIG. 2. Additionally and/or alternatively, the selected preference options may be stored in a memory associated with one or more data providers 110, such as, for example, DP databases 113, or in a memory associated with a cloud storage provider. The selected preference options may be retrieved when, for example, the disclosed embodiments determine display preferences, as discussed above in connection with block 415 of FIG. 4, and used to change the display of data, in a similar manner as discussed above in connection with block 430 of FIG. 4.

In addition, since information included transmitted throughout this process may be considered sensitive and/or valuable, data providers 110 and user devices 120 may develop and/or implement one or more mechanisms or procedures to securely transmit and receive the data. That is, data providers 110 and user devices 120 may use one or more cryptographic or encryption protocols and/or algorithms designed to securely transmit information, such as, for example and without limitation, one or more of Transport Layer Security (TLS), Secure Socket Layer (SSL), Diffie-Hellman key exchange, Internet key exchange, IPsec, Kerberos, Point-to-Point protocol, blind signatures, secure digital time-stamping, secure multiparty computation, undeniable signatures, deniable encryption, digital mixes, public key cryptography, RSA algorithm, Advanced Encryption Standard (AES), GOST, HAVAL, MD2, MD4, MD5, PANAMA, RIPEMD, SHA-0, SHA-1, SHA-256/224, SHA-3, WHIRPOOL, Tiger(2), RadioGatun, etc.

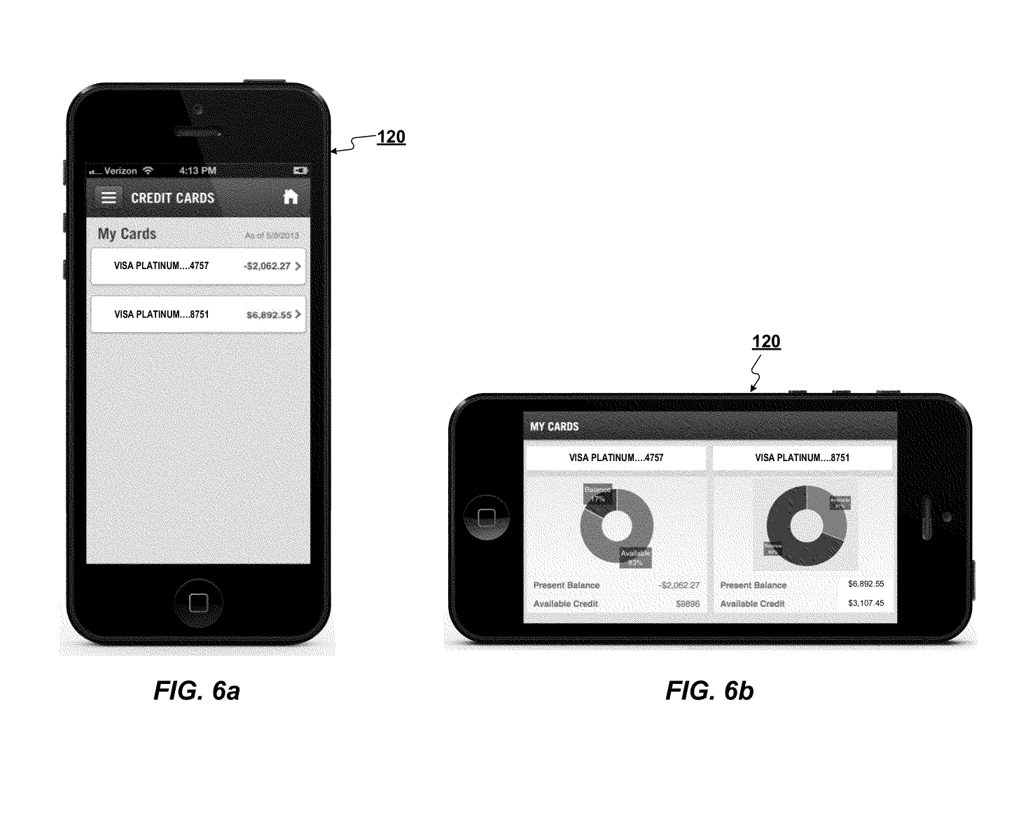

FIGS. 6a and 6b are example screenshots of generating and transforming data presentation, consistent with various embodiments. Specifically, FIGS. 6a and 6b illustrate example embodiments in which a user initiates display of data on a user device, such as user device 120, and the data is displayed according to a determined user device orientation, stored user preferences, and/or a current display format. For example, in the illustrations of FIGS. 6a and 6b, after a user has submitted a request for data via user device 120 to one or more data providers 110, the requested data may be received and stored in a memory associated with user device 120, as discussed above in connection with FIG. 3. The data may be retrieved (e.g., requested and received) from a single data provider 110, from multiple data providers 110, from a data provider 110 that collects and combines data from one or more other data providers 110, etc.

In the disclosed systems and methods, the received and stored data may the entire set of data required to perform the systems and methods disclosed herein. Thus, the data displayed on the display of user device 120 of FIG. 6a and the display of user device 120 of FIG. 6b may be drawn from the same set of data. As illustrated by FIGS. 6a and 6b, although the total set of data stored in memory associated with user device 120 may be unchanged, the subsets of data retrieved from the memory may be the same or different, whether in whole or in part. In other words, the disclosed systems and methods may request, receive, and store the entire data set upon a single user request that is subsequently sent to one or more data providers 110, and then selectively retrieve from memory subsets of the entire data set for display on user device 120 based on one or more of a determined orientation of user device 120, determination of prior data displayed on the display of user device 120, and stored display preferences.

Referring to the example of FIG. 6a, user device 120 may be triggered to initiate a data display. For example, as discussed above in block 405 of FIG. 4, user device 120 may be triggered to initiate data display upon, for example, validation and/or authentication of the user based on, for example, a user identification and/or user password. User device 120 also may be triggered to initiate data display upon a detection of a change in orientation of user device 120 and/or other determined gestures, eye movement, voice commands, etc. received from user via user device 120. As also discussed in connection with FIG. 4, at blocks 410, 415, and 420, the current device orientation may be determined, user display preferences may be determined, and other user input, if any, may also be determined. Based on one or more of these determinations (i.e., blocks 410, 415, and 420 of FIG. 4), the data stored in memory associated with user device 120 may be accessed and all or a subset of the stored data may be retrieved for display on user device 120.

In the illustration of FIG. 6a, the determined orientation of user device 120 is portrait, there was no other user input received via user device 120, and the user has set display preferences such that when user device 120 is in a portrait orientation, the data is to be displayed in a list format. Thus, a memory of user device 120 may be accessed and a subset of the stored data may be retrieved and displayed on a display of user device 120 in a simple list format (e.g., the present balance of Visa Platinum . . . 4757 and the present balance of Visa Platinum . . . 8751 as shown in FIG. 6a.

FIG. 6b illustrates an example of the disclosed systems and methods for transforming the data downloaded and stored in connection with FIG. 6a. That is, the data displayed on the display of user device 120 of FIG. 6b may be drawn from the same data that is downloaded and stored in connection with FIG. 6a. In the example of FIG. 6b, initiating data display may be triggered by a change in orientation of user device 120. As discussed in connection with FIG. 4, at blocks 410, 415, and 420, user device 120 may determine the current device orientation, user display preferences, and other user input, if any. Based on one or more of these determinations (i.e., blocks 410, 415, and 420 of FIG. 4), the data stored in memory associated with user device 120 may be accessed and all or a subset of the stored data may be retrieved for display on user device 120. Thus, referring to FIG. 6b, when user device 120 receives an indication of a change in orientation of user device 120, user device 120 may determine the current orientation (e.g., landscape), other user input (e.g., a request to see information related to two credit cards), determine user preferences for data display in the current orientation (e.g., while in landscape orientation, display present balances and available balances and donut graphs illustrating percentages of each), and retrieve from a memory associated with user device 120 a subset of the data that was previously downloaded and stored in connection with the illustration of FIG. 6a. As shown in FIG. 6b, when user device 120 is in a landscape orientation, the data displayed on user device 120 may include a textual statement of the present balance and available credit associated with Visa Platinum . . . 4757, along with a donut graph visually showing that, of the total credit line associated with Visa Platinum . . . 4757, the present balance is 17% and the available credit is 83%. And, as further shown in FIG. 6b, the data displayed on user device 120 may include a textual statement of the present balance and available credit associated with Visa Platinum . . . 8751, along with a donut graph visually showing that, of the total credit line associated with Visa Platinum . . . 8751, the present balance is 69% and the available credit is 31%.

When user device 120 changes orientation from landscape to portrait, the display may change from the example shown in FIG. 6b to the example shown in FIG. 6a. That, if user device 120 determines that user device 120 has changed from landscape orientation to portrait orientation, the user device 120 again may be triggered to initiate a data display. As discussed above in block 405 of FIG. 4, user device 120 may be triggered to initiate data display upon, for example, a detection of a change in orientation of user device 120 and/or other determined gestures or inputs received from user via user device 120. As also discussed in connection with FIG. 4, at blocks 410, 415, and 420, the current device orientation may be determined, user display preferences may be determined, and other user input or commands, if any, may also be determined. Based on one or more of these determinations (i.e., blocks 410, 415, and 420 of FIG. 4), the data stored in memory associated with user device 120 may be accessed and all or a subset of the stored data may be retrieved for display on user device 120.

In the illustration of FIG. 6a, the determined orientation of user device 120 is portrait, the user input a command to view data associated with two credit cards, and the user had previously set display preferences such that when user device 120 is in a portrait orientation, the data is to be displayed in a list format. Thus, a memory of user device 120 may be accessed and a subset of the stored data may be retrieved and again displayed on a display of user device 120 in a simple list format (e.g., the present balance of Visa Platinum . . . 4757 and the present balance of Visa Platinum . . . 8751), as shown in FIG. 6a.

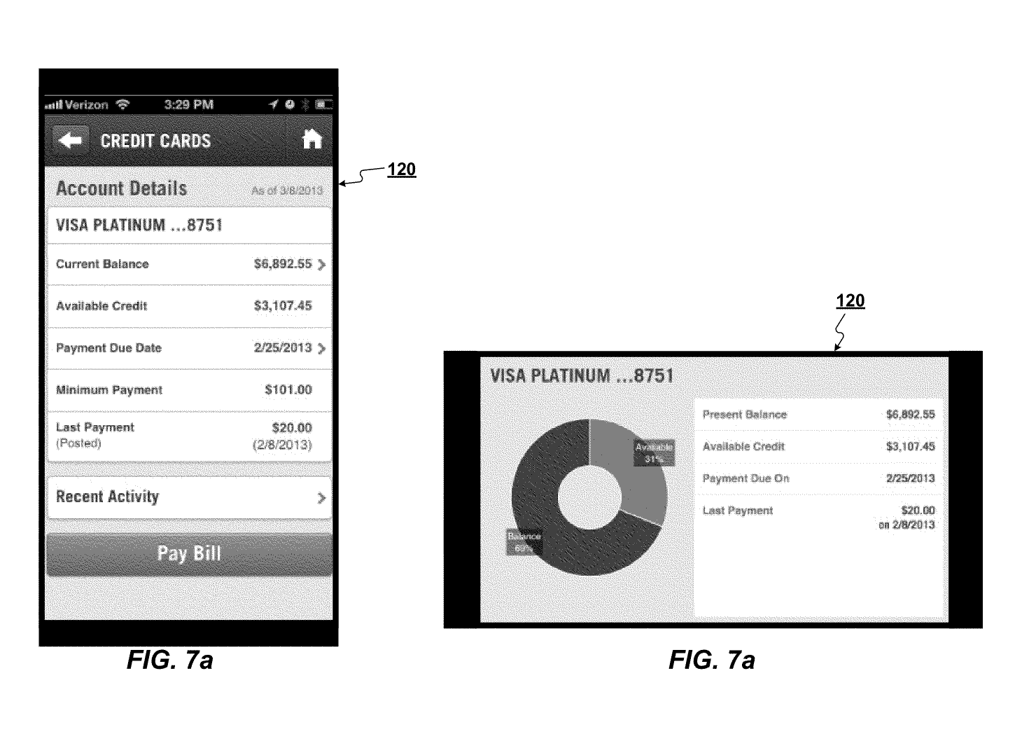

FIGS. 7a and 7b are example screenshots of generating and transforming data presentation, consistent with various embodiments. Specifically, FIGS. 7a and 7b illustrate example embodiments in which a user initiates display of data on a user device, such as user device 120, by selecting (e.g., “drill-down”) one of the accounts illustrated in FIGS. 6a and 6b, and the data is displayed according to a determined user device orientation, stored user preferences, and/or a current display format. Thus, the set of data used in connection with the illustrations of FIGS. 7a and 7b is the same set of data that is requested, received, and stored in a memory associated with user device 120, as discussed above in connection with FIGS. 6a and 6b.

In the example of FIG. 7a, initiating data display may be triggered by a user selecting one of the accounts illustrated in FIGS. 6a and 6b. The selection of one of the accounts may be one or more user commands (e.g., keyboard tap(s), screen tap(s), gesture(s), eye movement(s), voice command(s), etc.) that are detected by user device 120. As discussed in connection with FIG. 4, at blocks 410, 415, and 420, user device 120 may determine the current device orientation, user display preferences, and other user input, if any. Based on one or more of these determinations (i.e., blocks 410, 415, and 420 of FIG. 4), the data stored in memory associated with user device 120 may be accessed and all or a subset of the stored data may be retrieved for display on user device 120. Thus, referring to FIG. 7a, when user device 120 is triggered to display data, user device 120 may determine the current orientation (e.g., portrait), other user input (e.g., a request to see information related to only one of the two credit cards), determine user preferences for data display in the current orientation (e.g., while in portrait orientation and at the account summary level, display current balance, available credit, payment due date, minimum payment, last payment, and provide options to view recent activity and/or pay bill), and retrieve from a memory associated with user device 120 a subset of the data that was previously downloaded and stored in connection with the illustration of FIGS. 6a and 6b. As shown in FIG. 7a, when user device 120 is in a portrait orientation, the data displayed on user device 120 may include a textual statement of the current balance, available credit, payment due date, minimum payment, last payment associated with Visa Platinum . . . 8751.

FIG. 7b illustrates an example of the disclosed systems and methods for transforming the data downloaded and stored in connection with FIG. 7a. That is, the data displayed on the display of user device 120 of FIG. 7b may be drawn from the same data that is downloaded and stored in connection with FIG. 7a. In the example of FIG. 7b, initiating data display may be triggered by a change in orientation of user device 120. As discussed in connection with FIG. 4, at blocks 410, 415, and 420, user device 120 may determine the current device orientation, user display preferences, and other user input, if any. Based on one or more of these determinations (i.e., blocks 410, 415, and 420 of FIG. 4), the data stored in memory associated with user device 120 may be accessed and all or a subset of the stored data may be retrieved for display on user device 120. Thus, referring to FIG. 7b, when user device 120 receives an indication of a change in orientation of user device 120, user device 120 may determine the current orientation (e.g., landscape), other user input (e.g., a request to see information related to the credit card of FIG. 7a), determine user preferences for data display in the current orientation (e.g., while in landscape orientation and at the account summary level, display present balance, available credit, payment due date, last payment, and a donut graph), and retrieve from a memory associated with user device 120 a subset of the data that was previously downloaded and stored in connection with the illustration of FIGS. 6a and 6b. As shown in FIG. 7b, when user device 120 is in a landscape orientation, the data displayed on user device 120 may include a textual statement of the present balance, available credit, payment due date, and last payment associated with Visa Platinum . . . 8751, along with a donut graph visually showing that, of the total credit line associated with Visa Platinum . . . 8751, the present balance is 69% and the available credit is 31%.

Further, when user device 120 changes orientation from landscape to portrait, the display may change from the example shown in FIG. 7b to the example shown in FIG. 7a. That, if user device 120 determines that user device 120 has changed from landscape orientation to portrait orientation, the user device 120 again may be triggered to initiate a data display. As discussed above in block 405 of FIG. 4, user device 120 may be triggered to initiate data display upon, for example, a detection of a change in orientation of user device 120 and/or other determined gestures or inputs received from user via user device 120. As also discussed in connection with FIG. 4, at blocks 410, 415, and 420, the current device orientation may be determined, user display preferences may be determined, and other user input or commands, if any, may also be determined. Based on one or more of these determinations (i.e., blocks 410, 415, and 420 of FIG. 4), the data stored in memory associated with user device 120 may be accessed and all or a subset of the stored data may be retrieved for display on user device 120.

In the illustration of FIG. 7a, the determined orientation of user device 120 is portrait, the user input a command to view data associated with Visa Platinum . . . 8751, and the user had previously set display preferences such that when user device 120 is in a portrait orientation, the data is to be displayed in a list format. Thus, a memory of user device 120 may be accessed and a subset of the stored data may be retrieved and again displayed on a display of user device 120 in a simple list format (e.g., the current balance, available credit, payment due date, minimum payment, last payment associated with Visa Platinum . . . 8751), as shown in FIG. 7a.

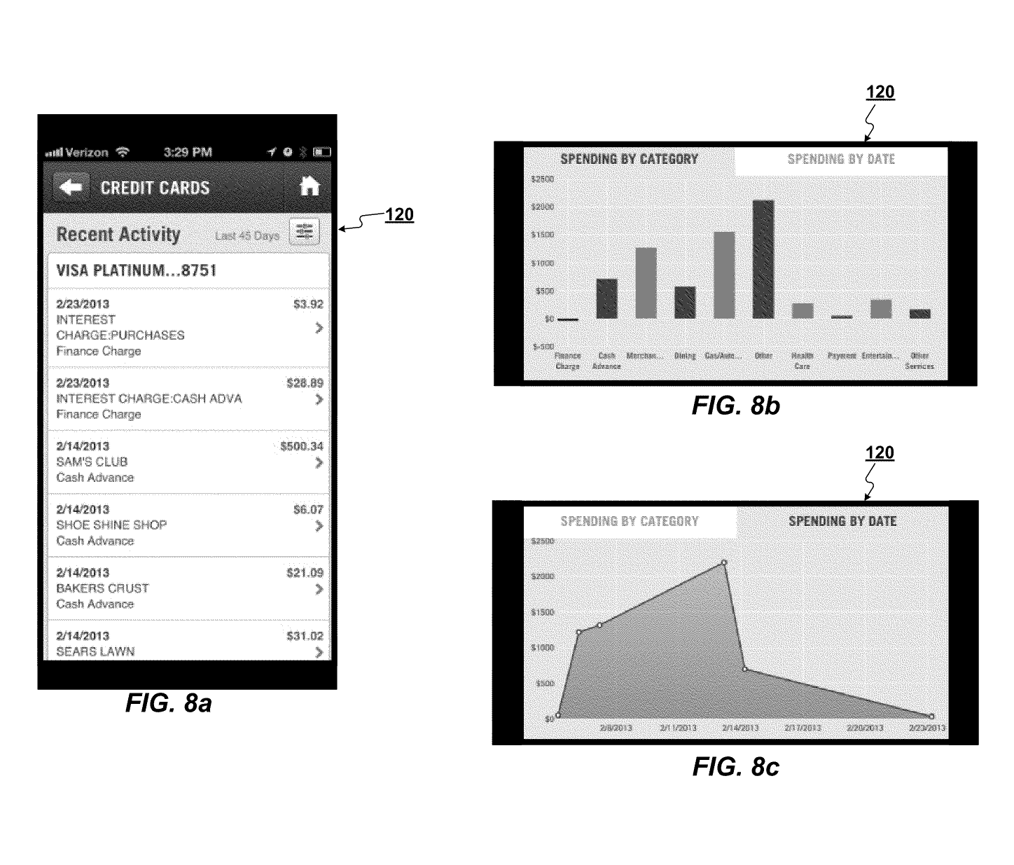

FIGS. 8a, 8b, and 8c are example screenshots of generating and transforming data presentation, consistent with various embodiments. Specifically, FIGS. 8a, 8b, and 8c illustrate example embodiments in which a user initiates display of data on a user device, such as user device 120, by selecting (e.g., “drill-down”) “recent activity” associated with the account illustrated in FIGS. 7a and 7b, and the data is displayed according to a determined user device orientation, stored user preferences, and/or a current display format. Thus, the set of data used in connection with the illustrations of FIGS. 8a, 8b, and 8c is the same set of data that is requested, received, and stored in a memory associated with user device 120, as discussed above in connection with FIGS. 6a, 6b, 7a, and 7b.

In the example of FIG. 8a, initiating data display may be triggered by a user selecting “recent activity” associated with the account illustrated in FIGS. 7a and 7b. The selection of “recent activity” may be one or more user commands (e.g., keyboard tap(s), screen tap(s), gesture(s), eye movement(s), voice command(s), etc.) that may be detected by user device 120. As discussed in connection with FIG. 4, at blocks 410, 415, and 420, user device 120 may determine the current device orientation, user display preferences, and other user input, if any. Based on one or more of these determinations (i.e., blocks 410, 415, and 420 of FIG. 4), the data stored in memory associated with user device 120 may be accessed and all or a subset of the stored data may be retrieved for display on user device 120. Thus, referring to FIG. 8a, when user device 120 is triggered to display data, user device 120 may determine the current orientation (e.g., portrait), other user input (e.g., a request to see account detail information), determine user preferences for data display in the current orientation (e.g., while in portrait orientation and at the account detail level, display all account activity, including debits and credits, merchants associated with debits and credits, dates of debits and credits, types of debits and credits, etc), and retrieve from a memory associated with user device 120 a subset of the data that was previously downloaded and stored in connection with the illustration of FIGS. 6a, 6b, 7a, and 7c. As shown in FIG. 8a, when user device 120 is in a portrait orientation, the data displayed on user device 120 may include a textual statement of all account activity, including debits and credits, merchants associated with debits and credits, dates of debits and credits, and types of debits and credits associated with Visa Platinum . . . 8751.

FIG. 8b illustrates an example of the disclosed systems and methods for transforming the data downloaded and stored in connection with FIG. 8a. That is, the data displayed on the display of user device 120 of FIG. 8b may be drawn from the same data that is downloaded and stored in connection with FIG. 8a. In the example of FIG. 8b, initiating data display may be triggered by a change in orientation of user device 120. As discussed in connection with FIG. 4, at blocks 410, 415, and 420, user device 120 may determine the current device orientation, user display preferences, and other user input, if any. Based on one or more of these determinations (i.e., blocks 410, 415, and 420 of FIG. 4), the data stored in memory associated with user device 120 may be accessed and all or a subset of the stored data may be retrieved for display on user device 120. Thus, referring to FIG. 8b, when user device 120 receives an indication of a change in orientation of user device 120, user device 120 may determine the current orientation (e.g., landscape), other user input (e.g., a request to see information related to the credit card of FIG. 8a), determine user preferences for data display in the current orientation (e.g., while in landscape orientation and at the account summary level, display spending by category in a bar graph form), and retrieve from a memory associated with user device 120 a subset of the data that was previously downloaded and stored in connection with the illustration of FIGS. 6a, 6b, 7a, 7b, and 8a. As shown in FIG. 8b, when user device 120 is in a landscape orientation, the data displayed on user device 120 may include a bar graph illustrating the amount of money spent in each of a number of categories (e.g., finance charges, cash advances, merchants, dining, gas/auto, other, health care, payment, entertainment, other services, etc.) associated with Visa Platinum . . . 8751. The number of categories and the types of categories may be determined by the user in advance through, for example, selecting display preference options, as discussed above in connection with FIG. 5. As also illustrated in FIG. 8b, user device 120 may provide an option to the user to change the view from spending by category to spending by date.

FIG. 8c illustrates an example of the disclosed systems and methods for transforming the data downloaded and stored in connection with FIGS. 8a and 8b. That is, the data displayed on the display of user device 120 of FIG. 8c may be drawn from the same data that is downloaded and stored in connection with FIGS. 8a and 8b In the example of FIG. 8c, initiating data display may be triggered by a user selecting the option of changing the view from “spending by category” to “spending by date.” As discussed in connection with FIG. 4, at blocks 410, 415, and 420, user device 120 may determine the current device orientation, user display preferences, and other user input, if any. Based on one or more of these determinations (i.e., blocks 410, 415, and 420 of FIG. 4), the data stored in memory associated with user device 120 may be accessed and all or a subset of the stored data may be retrieved for display on user device 120. Thus, referring to FIG. 8c, when user device 120 receives an indication of a desired change in view of the data currently displayed on a display of user device 120, user device 120 may determine the current orientation (e.g., landscape), other user input (e.g., a request to see information related to the “spending by date” associated with credit card of FIG. 8a), determine user preferences for data display in the current orientation (e.g., while in landscape orientation and at the account summary level and with selection of “spending by date,” display spending by date in a line, plot, or area graph form), and retrieve from a memory associated with user device 120 a subset of the data that was previously downloaded and stored in connection with the illustration of FIGS. 6a, 6b, 7a, 7b, 8a, and 8b. As shown in FIG. 8c, when user device 120 is in a landscape orientation, the data displayed on user device 120 may include a line graph illustrating the amount of money spent over a period of time (e.g., week-by-week, bi-week-by-bi-week, day-by-day, etc.) associated with Visa Platinum . . . 8751. The time periods may be determined by the user in advance through, for example, selecting display preference options, as discussed above in connection with FIG. 5.

Further, when user device 120 changes orientation from landscape to portrait, the display may change from the examples shown in FIGS. 8b and 8c to the example shown in FIG. 8a. That, if user device 120 determines that user device 120 has changed from landscape orientation to portrait orientation, the user device 120 again may be triggered to initiate a data display. As discussed above in block 405 of FIG. 4, user device 120 may be triggered to initiate data display upon, for example, a detection of a change in orientation of user device 120 and/or other determined gestures or inputs received from user via user device 120. As also discussed in connection with FIG. 4, at blocks 410, 415, and 420, the current device orientation may be determined, user display preferences may be determined, and other user input or commands, if any, may also be determined. Based on one or more of these determinations (i.e., blocks 410, 415, and 420 of FIG. 4), the data stored in memory associated with user device 120 may be accessed and all or a subset of the stored data may be retrieved for display on user device 120.

In the illustration of FIG. 8a, the determined orientation of user device 120 is portrait, the user input a command to view data associated with Visa Platinum . . . 8751, and the user had previously set display preferences such that when user device 120 is in a portrait orientation, the data is to be displayed in a list format. Thus, a memory of user device 120 may be accessed and a subset of the stored data may be retrieved and again displayed on a display of user device 120 in a simple list format (e.g., ll account activity, including debits and credits, merchants associated with debits and credits, dates of debits and credits, and types of debits and credits associated with Visa Platinum . . . 8751), as shown in FIG. 8a.

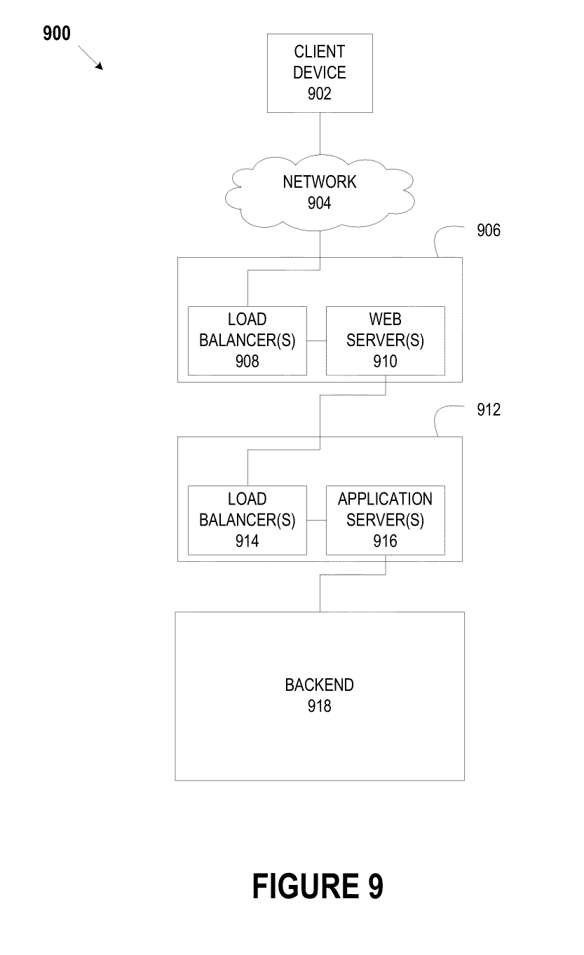

FIG. 9 depicts an example system 900 that may enable a financial institution, for example, to provide network services to its customers. As shown in FIG. 9, system 900 may include a client device 902, a network 904, a front-end controlled domain 906, a back-end controlled domain 912, and a backend 918. Front-end controlled domain 906 may include one or more load balancers 908 and one or more web servers 910. Back-end controlled domain 912 may include one or more load balancers 914 and one or more application servers 916.

Client device 902 may be a network-enabled computer. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. In various example embodiments, client device 902 may be similar to user device 120 as shown and described herein. The one or more network-enabled computers of the example system 900 may execute one or more software applications to enable, for example, network communications.

Client device 902 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 904 may be one or more of a wireless network, a wired network, or any combination of a wireless network and a wired network. For example, network 904 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 904 may include, without limitation, telephone lines, fiber optics, IEEE Ethernet 902.3, a wide area network (WAN), a local area network (LAN) or a global network such as the Internet. Also, network 904 may support an Internet network, a wireless communication network, a cellular network, or the like, or any combination thereof. Network 904 may further include one network, or any number of example types of networks mentioned above, operating as a stand-alone network or in cooperation with each other. Network 904 may utilize one or more protocols of one or more network elements to which they are communicatively couples. Network 904 may translate to or from other protocols to one or more protocols of network devices. Although network 904 is depicted as a single network, it should be appreciated that according to one or more embodiments, network 904 may comprise a plurality of interconnected networks, such as, for example, the Internet, a service provider's network, a cable television network, corporate networks, and home networks.

Front-end controlled domain 906 may be implemented to to provide security for backend 918. Load balancer(s) 908 may distribute workloads across multiple computing resources, such as, for example computers, a computer cluster, network links, central processing units or disk drives. In various embodiments, load balancer(s) 910 may distribute workloads across, for example, web server(S) 916 and/or backend 918 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 908 may include software that monitoring the port where external clients, such as, for example, client device 902, connect to access various services of a financial institution, for example. Load balancer(s) 908 may forward requests to one of the application servers 916 and/or backend 918 servers, which may then reply to load balancer 908. This may allow load balancer(s) 908 to reply to client device 902 without client device 902 ever knowing about the internal separation of functions. It also may prevent client devices from contacting backend servers directly, which may have security benefits by hiding the structure of the internal network and preventing attacks on backend 918 or unrelated services running on other ports, for example.

A variety of scheduling algorithms may be used by load balancer(s) 908 to determine which backend server to send a request to. Simple algorithms may include, for example, random choice or round robin. Load balancers 908 also may account for additional factors, such as a server's reported load, recent response times, up/down status (determined by a monitoring poll of some kind), number of active connections, geographic location, capabilities, or how much traffic it has recently been assigned.

Load balancers 908 may be implemented in hardware and/or software. Load balancer(s) 908 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 910 may include hardware (e.g., one or more computers) and/or software (e.g., one or more applications) that deliver web content that can be accessed by, for example a client device (e.g., client device 902) through a network (e.g., network 904), such as the Internet. In various examples, web servers, may deliver web pages, relating to, for example, online banking applications and the like, to clients (e.g., client device 902). Web server(s) 910 may use, for example, a hypertext transfer protocol (HTTP or sHTTP) to communicate with client device 902. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 910 may respond with the content of that resource or an error message if unable to do so. The resource may be, for example a file on stored on backend 918. Web server(s) 910 also may enable or facilitate receiving content from client device 902 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 910 can be scripted in separate files, while the actual server software remains unchanged.

Load balancers 914 may be similar to load balancers 908 as described above.

Application server(s) 916 may include hardware and/or software that is dedicated to the efficient execution of procedures (e.g., programs, routines, scripts) for supporting its applied applications. Application server(s) 916 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 916 may act as a set of components accessible to, for example, a financial institution or other entity implementing system 900, through an API defined by the platform itself. For Web applications, these components may be performed in, for example, the same running environment as web server(s) 910, and application servers 916 may support the construction of dynamic pages. Application server(s) 916 also may implement services, such as, for example, clustering, fail-over, and load-balancing. In various embodiments, where application server(s) 916 are Java application servers, the web server(s) 916 may behaves like an extended virtual machine for running applications, transparently handling connections to databases associated with backend 918 on one side, and, connections to the Web client (e.g., client device 902) on the other.

Backend 918 may include hardware and/or software that enables the backend services of, for example, a financial institution or other entity that maintains a distributes system similar to system 900. For example, backend 918 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 918 may be associated with various databases, including account databases that maintain, for example, customer account information, product databases that maintain information about products and services available to customers, content databases that store content associated with, for example, a financial institution, and the like. Backend 918 also may be associated with one or more servers that enable the various services provided by systems 900 and/or 100.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.”

As may be understood, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As may also be understood, all language such as “up to,” “at least,” “greater than,” “less than,” and the like include the number recited and refer to ranges which can be subsequently broken down into subranges as discussed above. Finally, as may be understood, a range includes each individual member. Thus, for example, a group having 1-3 members refers to groups having 1, 2, or 3 members. Similarly, a group having 1-5 members refers to groups having 1, 2, 3, 4, or 5 members, and so forth.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A computer-implemented method for generating and transforming data presentation on a user device, comprising:
receiving, using a processor, a request for a set of data;
submitting, by the processor, the request for the set of a data to a computer server system, wherein the request includes a user identification and a user password;
receiving, from the computer server system, the requested set of data;
storing, in a memory, the received set of data;
retrieving, from the memory, a subset of the received set of data; and
causing the subset of the received set of data to be shown on a display associated with the user device based on a detected orientation of the user device, display preferences, and user input.

2. The computer-implemented method of claim 1, wherein the receiving the request for the set of data includes:
receiving, via a user interface of the user device, the request for the set of data.

3. The computer-implemented method of claim 1, wherein the submitting the request to the computer server system includes:
receiving, via the user device, the user identification and the user password;
authenticating the user identification and the user password; and
submitting, to the computer server system, the request and the authenticated user identification and user password.

4. The computer-implemented method of claim 1, wherein the submitting the request to the computer server system includes:
transmitting, via a network, the request to the computer server system.

5. The computer-implemented method of claim 1, wherein the causing the subset of the received set of data to be displayed on the display includes:
accessing, in the memory, the stored set of data; and
extracting the subset of the data to be shown on the display.

6. The computer-implemented method of claim 1, wherein the receiving the requested set of data includes:
receiving the set of data in a standardized format.

7. The computer-implemented method of claim 1, wherein the requested set of data is associated with a financial account.

8. The computer-implemented method of claim 1, wherein the computer server system is associated with a financial services institution.

9. The computer-implemented method of claim 1, wherein the requested set of data is associated with a financial account.

10. A computer-implemented method for generating and transforming data presentation, comprising:
receiving, via a user interface of a user device, a request for data;
determining an orientation of a display associated with the user device;
determining user preferences corresponding to a user preferred display format;
retrieving, from a memory associated with the user device, stored data; and
displaying, on a display associated with the user device, the retrieved data in a display format based on the detected orientation and the user preferred display format.

11. The computer-implemented method of claim 10, further including:
receiving, via the user interface of the user device, a user identification and a user password; and
authenticating, by the user device, the user identification and the user password.

12. The computer-implemented method of claim 11, wherein the user identification and the user password are associated with a financial account.

13. The computer-implemented method of claim 10, wherein displaying the retrieved data in the display format includes:
when the user identification and the user password are authenticated, displaying the retrieved data in the display format based on the detected orientation and the user preferred display format.

14. The computer-implemented method of claim 10, wherein the retrieving the stored data includes:
accessing, in the memory, the stored data; and
extracting display data to be shown on the display.

15. The computer-implemented method of claim 10, wherein the determining the orientation of the display includes:
receiving, from an orientation unit of the user device, an orientation indication of one of a portrait orientation and a landscape orientation.

16. The computer-implemented method of claim 15, wherein the receiving the orientation indication includes:
receiving, from then orientation unit of the user device, an indication of an angle of the user device.

17. The computer-implemented method of claim 10, wherein the determining the orientation of the display includes:
receiving, via the user interface of the user device, a user display orientation input.

18. The computer-implemented method of claim 10, wherein the data is associated with a financial account.

19. A mobile device, comprising:
a mobile banking interface associated with a mobile banking application that receives a request for a financial data;
a communication interface that transmits the request for financial data to a financial institution computer server system and receives from the computer server system, the requested financial data;
memory associated with the mobile banking application that stores the received financial data;
an orientation detector that detects the orientation of the mobile device; and
a processor that causes the subset of the received financial data to be shown on a display associated with the mobile device based on a detected orientation of the user device, display preferences, and user input.

20. A mobile device, comprising:
a mobile banking application that receives, via a user interface of the mobile device, a request for financial data and user preferences associated with the mobile banking application;
an orientation detector that determines an orientation of a display associated with the mobile device;
a mobile device processor that determines the user preferences corresponding to a user preferred display format when the mobile banking application is in use, retrieves, from a memory associated with the user device, stored data, and displays, on the display of the mobile device, the retrieved data in a display format based on the detected orientation and the user preferred display format.
